(19) United States
(12) Patent Application Publication
(10) Pub. No.: US 2024/0304124 A1
(43) Pub. Date: Sep. 12, 2024

(54) Apparatus for Branding Compliant Ground

(71) Applicant: James Russell Nicholson, Pensacola, FL (US)

(72) Inventor: James Russell Nicholson, Pensacola, FL (US)

(21) Appl. No.: 18/598,361

(22) Filed: Mar. 7, 2024

Related U.S. Application Data
(60) Provisional application No. 63/489,042, filed on Mar. 8, 2023.

(51) Int. Cl. G09F 19/22

(52) U.S. Cl. CPC G09F 19/228

(57) ABSTRACT

An apparatus and method for embossing and/or debossing compliant ground, such as bunker sand, beach sand, clay, dirt, snow, etc. The apparatus includes a pole, a tamping tool, and a blank. Using the apparatus, an interchangeable blank is pressed into compliant ground and then lifted off the compliant ground, leaving behind an emboss and/or deboss on the compliant ground corresponding to raised area on the blank.

### CROSS REFERENCE TO RELATED APPLICATIONS

This application claims the benefit of U.S. Provisional Application No. 63/489,042 filed on Mar. 8, 2023.

### BRIEF DESCRIPTION OF THE DRAWINGS

FIG. 1 is a view of an embodiment of the apparatus standing vertically with the tamping tool flat on the ground.

FIG. 2 is a view of an embodiment of the apparatus standing vertically with the tamping tool turned from the ground.

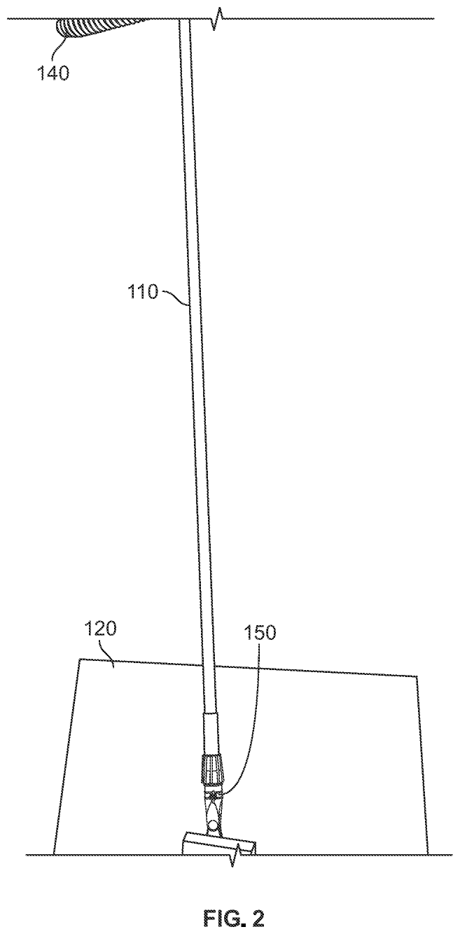

FIG. 3 is a closeup view of an embodiment of the top of the tamping tool.

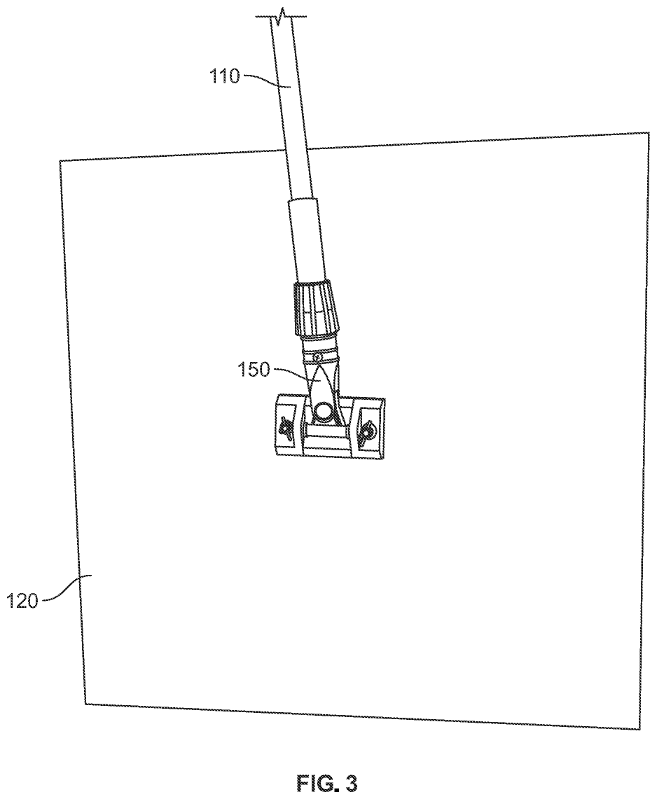

FIG. 4 is a view of an embodiment of the apparatus laid flat with the bottom of the tamping tool turned upwards.

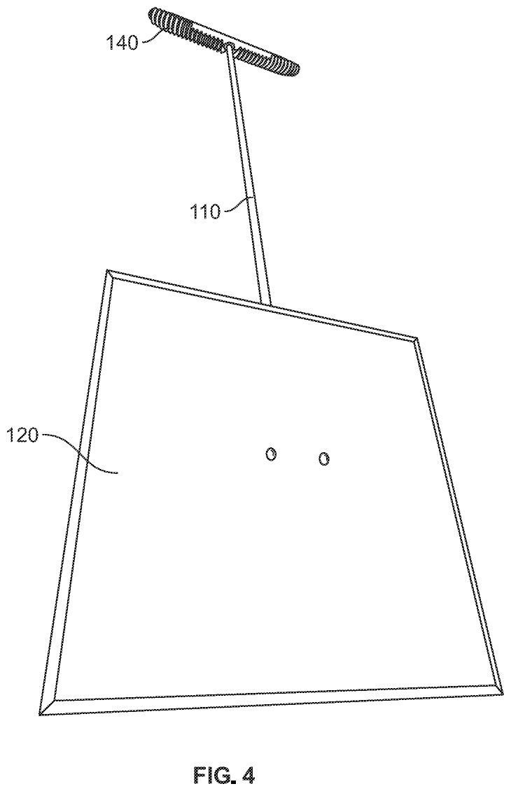

FIG. 5 is a closeup top-down view of an embodiment of the rake head of the apparatus.

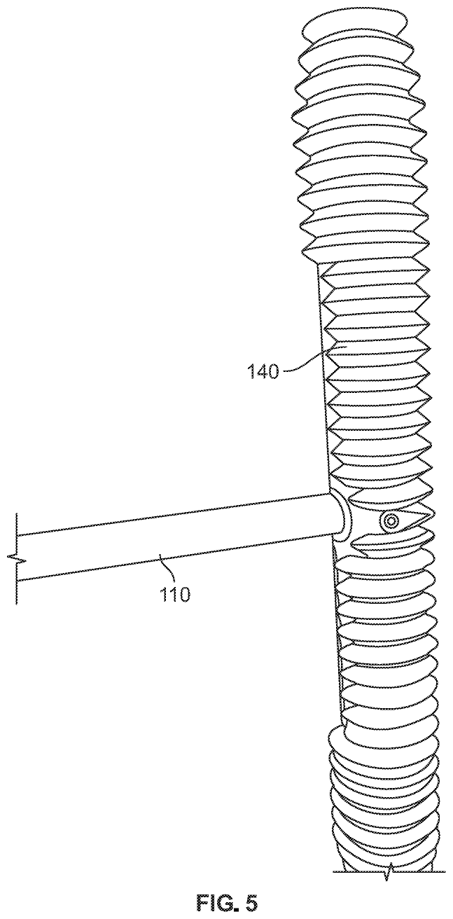

FIG. 6 is a closeup sideview of an embodiment of the rake head of the apparatus.

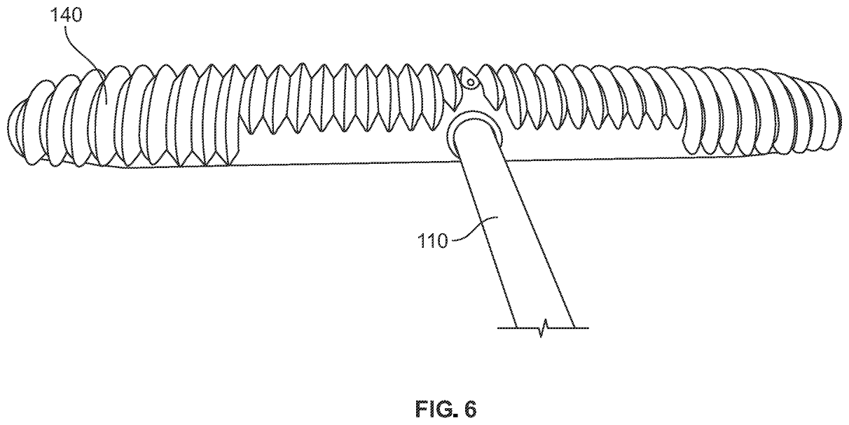

FIG. 7 is a view of the bottom side of an embodiment of the blank of the apparatus.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

### Apparatus for Branding Compliant Ground

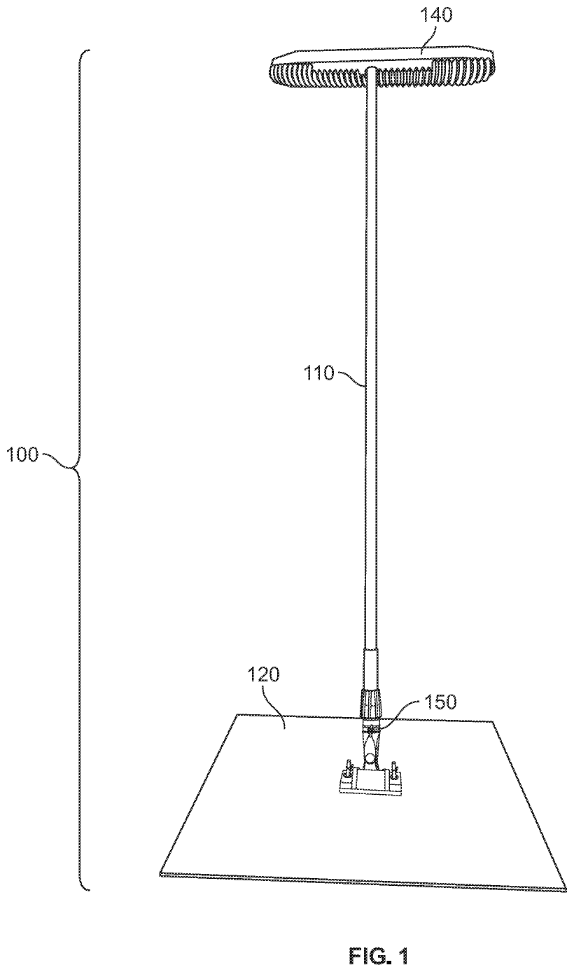

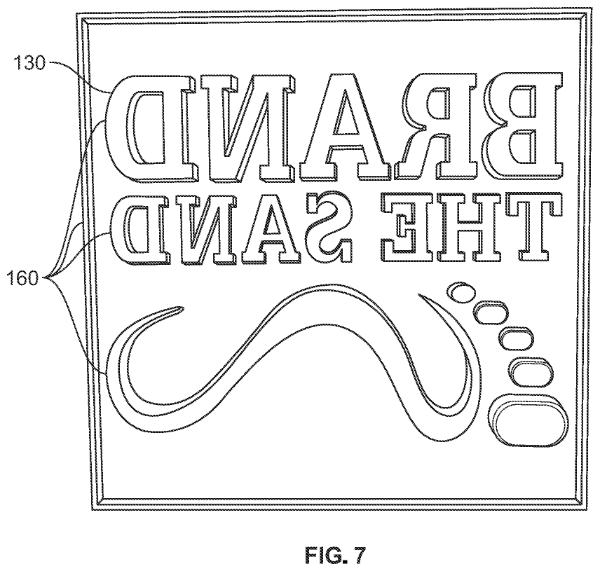

With reference to FIG. 1 and FIG. 7, the present invention relates to an apparatus for branding compliant ground. The apparatus 100 comprises at least one pole 110, at least one tamping tool 120, and at least one blank 130. The tamping tool 120 is attached to the pole 110 and the blank 130 is removably attached to the tamping tool 120. In some embodiments, the tamping tool 120 is a flat planar surface and the tamping tool 120 and the blank 130 have matching geometries. In some embodiments, the tamping tool 120 is removably attached to the pole 110. In some embodiments, the tamping tool 120 is attached to a distal end of the pole 110.

In some embodiments, a rake head 140 is attached to the pole 110. In some embodiments, the rake head 140 is attached to the distal end of the pole 110 opposite the tamping tool 120. In some embodiments, the tamping tool 120 is attached to the pole 110 via a ball joint 150 or a pivot joint 150. In some embodiments, the blank 130 is a flat planar surface. In some embodiments, the blank 130 is removably attached to the tamping tool 120 via Velcro, latches, adhesive, clips, loops, or a combination thereof. The blank 130 can be manufactured via 3D printing, injection molding, machining, or a combination thereof. In some embodiments, the blank 130 has at least one raised area 160 corresponding to a branding element, words, numbers, design, insignia or the like.

In some embodiments, the raised area 160 allows for the embossing and/or debossing of compliant ground, such as bunker sand, beach sand, clay, dirt, snow, etc. In some embodiments, the depth of the raised area 160 is within a range of 0.125 to 0.5 inches.

In some embodiments, the sidewalls of the raised area 160 are tapered in a manner that allows for the removal of blank 130 from compliant ground without disturbing the pattern created by pressing the raised area 160 into the compliant ground. In some embodiments, the sidewalls of the raised area 160 are tapered 60-degrees such that the narrow end is distal to blank 130.

### Method for Branding Compliant Ground

With reference to FIG. 1 and FIG. 7, the method of using the apparatus 100 to brand compliant ground comprises providing at least one pole 110, at least one tamping tool 120, and at least one blank 130 with a raised area 160, removably attaching the blank 130 with the raised area 160 to the tamping tool 120, pressing the blank 130 with the raised area 160 into compliant ground, and lifting the blank 130 up from the compliant ground, resulting in the embossing and/or debossing of the compliant ground with the pattern corresponding to the raised area 160 of the blank 130. In some embodiments, the tamping tool 120 is removably attached to the pole 110. In some embodiments, different raised area 160 patterns can be on the blank 130 to allow for the creation of different patterns in compliant ground. In some embodiments, the raised area 160 of the blank 130 is created via 3D printing, injection molding, machining, or a combination thereof.

The enumerated listing of items does not imply that any or all of the items are mutually exclusive, unless expressly specified otherwise. The terms “a”, “an” and “the” mean “one or more”, unless expressly specified otherwise.

Elements of the invention that are in communication with each other need not be in continuous communication with each other, unless expressly specified otherwise. In addition, elements of the invention that are in communication with each other may communicate directly or indirectly through one or more other elements or other intermediaries.

One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that any alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. An apparatus for branding compliant ground, comprising:
at least one pole;
at least one tamping tool; and
at least one blank;
wherein the tamping tool is attached to the pole;
wherein the blank is removably attached to the tamping tool.

2. The apparatus of claim 1, wherein the tamping tool is a flat planar surface.

3. The apparatus of claim 1, wherein the tamping tool and the blank have matching geometries.

4. The apparatus of claim 1, wherein the tamping tool is removably attached to the pole.

5. The apparatus of claim 1, wherein the tamping tool is attached to a distal end of the pole.

6. The apparatus of claim 5, wherein a rake head is attached to the pole.

7. The apparatus of claim 6, wherein the rake head is attached to the pole at the distal end opposite the tamping tool.

8. The apparatus of claim 1, wherein the tamping tool is attached to the pole via a ball joint.

9. The apparatus of claim 1, wherein the tamping tool is attached to the pole via a pivot joint.

10. The apparatus of claim 1, wherein the blank is a flat planar surface.

11. The apparatus of claim 1, wherein the blank is removably attached to the tamping tool via Velcro, latches, adhesive, clips, loops, or a combination thereof.

12. The apparatus of claim 1, wherein the blank is created via 3D printing, injection molding, machining, or a combination thereof.

13. The apparatus of claim 1, wherein the blank includes at least one raised area.

14. The apparatus of claim 13, wherein at least one raised area enables embossing, debossing, or a combination thereof, of complaint ground.

15. The apparatus of claim 13, wherein at least one raised area has a depth within a range of 0.125 inches to 0.5 inches.

16. The apparatus of claim 13, wherein at least one raised area has sidewalls.

17. The apparatus of claim 16, wherein the sidewalls of at least one raised area are tapered.

18. The apparatus of claim 17, wherein the sidewalls of the raised area are tapered 60-degrees such that the narrow end is distal to the blank.

19. A method of branding compliant ground, comprising:
providing at least one pole;
providing at least one tamping tool attached to a distal end of the pole;
providing at least one blank;
removably attaching the blank to the tamping tool;
pressing the blank into compliant ground; and
lifting the blank off the compliant ground.

20. The method of claim 19, wherein the tamping tool is removably attached to the pole.
